(19) United States
(12) Patent Application Publication
(10) Pub. No.: US 2020/0151738 A1
(43) Pub. Date: May 14, 2020

(54) Data Driven Product Authenticity Verification

(71) Applicant: EVRYTHNG Limited, London (GB)

(72) Inventors: Dominique David Guinard, Yverdon-les-Bains (CH); Joël Antoine Ghislain Vogt, London (GB); Niall Terence Murphy, Commugny (CH)

(21) Appl. No.: 16/183,813

(22) Filed: Nov. 8, 2018

(51) Int. Cl. G06Q 30/00; G06K 19/06; G06K 19/077; G06K 19/14

(52) U.S. Cl. CPC G06Q 30/0185; G06K 19/145; G06K 19/07758; G06K 19/06037

(57) ABSTRACT

Authenticity of a product is determined based on events about the product and combining the authentication probabilities contained in each event to an overall authenticity score.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to product authenticity verification, and, more particularly, to methods, systems and devices supporting real-time data-driven product authenticity verification.

### BACKGROUND

Due to the goodwill value of a brand, branded products such as consumer packaged goods and apparel products experience a significant level of counterfeiting (counterfeit market) or follow supply chain routes that were not intended nor authorized by the brand (gray market). These problems, referred to here as authenticity problems, are significant and lead to large losses for brands.

Most solutions to these authenticity problems require the use of special markers on products (e.g., holographic tags or the like). The costs of such tags are high and establishing authenticity based on such tags is non-trivial and requires special training and applications.

It is desirable, and an object hereof, to provide a system that allows determining whether a product is authentic without requiring tags beyond standard barcodes (e.g., 1D or 2D). It is further desirable and an object hereof to determine product authenticity based on a combination data from and/or about the product. It is further desirable and an object hereof to determine product authenticity using learning algorithms. It is also desirable and an object hereof to allow a user with a mobile device to check and/or confirm the authenticity and/or provenance of a product in a seamless manner, without requiring special training.

### SUMMARY

The present invention is specified in the claims as well as in the below description. Preferred embodiments are particularly specified in the dependent claims and the description of various embodiments.

In some aspect hereof, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method of determining authenticity of a physical product, the method including: determining an identifier for the product, the identifier being encoded in indicia associated with the product. The method of determining authenticity also includes using the identifier to access a product authentication system. The method of determining authenticity also includes determining a first score based on an analysis of the product. The method of determining authenticity also includes determining a second score based on an analysis of at least one tag associated with the product. The method of determining authenticity also includes determining a product authenticity score as a function of the first score and the second score; and then. The method of determining authenticity also includes based on the product authenticity score, providing an indication of authenticity of the product. Other embodiments of this aspect include corresponding computer systems, apparatus, and computer programs recorded on one or more computer storage devices, each configured to perform the actions of the methods.

Implementations may include one or more of the following features. The method where the indicia are encoded in and/or on the product. The method where the indicia are encoded in and/or on the at least one tag associated with the product. The method where the indicia are encoded in a barcode. The method where the barcode includes a two-dimensional barcode. The method where the indicia are encoded in an RFID tag. The method where the indicia are encoded in an NFC tag. The method where the indicia include a uniform resource locator (URL). The method where the first score is determined in (c)(1) based on an analysis of one or more images of the product. The method where the one or more images of the product are obtained from a user's device. The method where the second score is determined in (c)(2) based on an analysis of at least one tag associated with the product. The method where the analysis of the at least one tag is based on an analysis of one or more images of the at least one tag. The method where the one or more images of the at least one tag are obtained from a user's device. The method where the first score is a value in the range 0 to 1 indicative of a first probability that the product is authentic. The method where the second score is a value in the range 0 to 1 indicative of a second probability that the at least one tag is authentic. The method where the product authenticity score is determined as an average of a weighted sum of at least the first score and the second score. The method further including: the product authentication system determining a third score based on an analysis of a context of the product, and where the product authenticity score is a function of the first score and the second score and the third score. The method where the third score is a value in the range 0 to 1 indicative of a third probability that the context is anomalous. The method where the context of the product is based on one or more of: (i) whether the product was activated at manufacturing time, (ii) information related to transportation of the product; and (iii) missing and/or contradictory information about the product. The method where the product authenticity score is determined as an average of a weighted sum of at least the first score and the second score and the third score. The method where the product authenticity score is determined in response to a request from a user. The method where the request was initiated based on a scan of indicia associated with the product. The method where the indication of authenticity of the product is determined based on the product authenticity score relative to a threshold value. The method where the analysis of the product uses a digital representation of the product. The method where the product authentication system is accessible as a web-based application. The method where using the identifier in (b) includes resolving a URL (uniform resource locator) associated with the product. The method where the URL is encoded in the indicia associated with the product. The method where accessing the product authentication system is performed in response to scanning the indicia associated with the product. The method where at least one of the first score and/or the second score and/or the third score is determined using external information. The method where at least one of the first score and/or the second score and/or the third score is determined using one or more formal models. The method where at least one of the first score and/or the second score and/or the third score is determined using at least one machine-learning model. The method where the at least one machine-learning model was trained using a set of related products. Implementations of the described techniques may include hardware, a method or process, or computer software on a computer-accessible medium.

A skilled reader will understand, that any method described above or below and/or claimed and described as a sequence of steps or acts is not restrictive in the sense of the order of steps or acts.

Below is a list of method or process embodiments. Those will be indicated with a letter “M”. Whenever such embodiments are referred to, this will be done by referring to “M” embodiments.

M1. A method of determining authenticity of a physical product, the method comprising:
determining an identifier for the product, said identifier being encoded in indicia associated with the product;
using said identifier to access a product authentication system;
said product authentication system:
determining a first score based on an analysis of the product;
determining a second score based on an analysis of at least one tag associated with the product; and
determining a product authenticity score as a function of the first score and the second score; and then
based on said product authenticity score, providing an indication of authenticity of the product.
M2. The method of embodiment M1, wherein said indicia are encoded, at least in part, in and/or on the product.
M3. The method of embodiments M1 or M2, wherein said indicia are encoded, at least in part, in and/or on the at least one tag associated with the product.
M4. The method of any one of the preceding embodiments, wherein said indicia are encoded, at least in part, in a barcode and/or on a radio frequency identification (RFID) tag and/or a near field communication (NFC) tag.
M5. The method of embodiment M4, wherein the barcode comprises a two-dimensional barcode.
M6. The method of any one of the preceding embodiments, wherein the indicia comprise a uniform resource identifier (URI).
M7. The method of any one of the preceding embodiments, wherein the first score is determined based on an analysis of one or more images of the product.
M8. The method of embodiment M7, wherein the one or more images of the product are obtained from a user's device and/or from an automated and/or dedicated scanner device (such as a handheld barcode scanner or an RFID gate).
M9. The method of any one of the preceding embodiments, wherein the second score is determined based on an analysis of at least one tag associated with the product.
M10. The method of embodiment M1 wherein the analysis of the at least one tag is based on an analysis of one or more images of the at least one tag.
M11. The method of embodiment M10, wherein the one or more images of the at least one tag are obtained from a user's device.
M12. The method of any one of the preceding embodiments, wherein the first score is a value in the range 0 to 1 indicative of a first probability that the product is authentic.
M13. The method of any one of the preceding embodiments, wherein the second score is a value in the range 0 to 1 indicative of a second probability that the at least one tag is authentic.
M14. The method of any one of the preceding embodiments, wherein the product authenticity score is determined as an average of a weighted sum of at least the first score and the second score.
M15. The method of any one of the preceding embodiments, further comprising: said product authentication system determining a third score based on an analysis of a context of the product, and wherein said product authenticity score is a function of the first score and the second score and the third score.
M16. The method of embodiment M15, wherein the third score is a value in the range 0 to 1 indicative of a third probability that the context is anomalous.
M17. The method of embodiments M15 or M16, wherein the context of the product is based on one or more of: (i) whether the product was activated at manufacturing time, (ii) information related to transportation of the product; and (iii) missing and/or contradictory information about the product.
M18. The method of any one of the preceding embodiments, wherein the product authenticity score is determined as an average of a weighted sum of at least the first score and the second score and the third score.
M19. The method of any one of the preceding embodiments, wherein the product authenticity score is determined in response to a request from a user.
M20. The method of embodiment M19, wherein the request was initiated based on a scan of indicia associated with the product.
M21. The method of any one of the preceding embodiments, wherein the indication of authenticity of the product is determined based on the product authenticity score relative to a threshold value.
M22. The method of any one of the preceding embodiments, wherein the analysis of the product uses a digital representation of the product.
M23. The method of any one of the preceding embodiments, wherein the product authentication system is accessible as a web-based application.
M24. The method of any one of the preceding embodiments, wherein using said identifier in (B) comprises resolving a URL (Uniform Resource Locator) associated with the product.
M25. The method of embodiment M24, wherein the URL is encoded in the indicia associated with the product.
M26. The method of embodiment M25, wherein accessing the product authentication system is performed in response to scanning the indicia associated with the product.
M27. The method of any one of the preceding embodiments, wherein at least one of the first score and/or the second score and/or the third score is determined using external information.
M28. The method of any one of the preceding embodiments, wherein at least one of the first score and/or the second score and/or the third score is determined using one or more formal models.
M29. The method of any one of the preceding embodiments, wherein at least one of the first score and/or the second score and/or the third score is determined using at least one machine-learning model.
M30. The method of embodiment M29, wherein the at least one machine-learning model was trained using a set of related products.

Below are system embodiments. Those will be indicated with a letter “S”. Whenever such embodiments are referred to, this will be done by referring to “S” embodiments.
S31. A system comprising:
(a) hardware including memory and at least one processor, and
(b) a service running on said hardware, wherein said service is configured to: perform the method of any one of the preceding method embodiments M1-M30.

Below are article of manufacture embodiments. Those will be indicated with a letter “A”. Whenever such embodiments are referred to, this will be done by referring to “A” embodiments.
A32. An article of manufacture comprising non-transitory computer-readable media having computer-readable instructions stored thereon, the computer readable instructions including instructions for implementing a computer-implemented method, said method operable on a device comprising hardware including memory and at least one processor and running a service on said hardware, said method comprising the method of any one of the preceding method embodiments M1-M30.

The above features, along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of product authentication;

FIG. 2 depicts an architecture according to exemplary embodiments hereof;

FIG. 3 depicts an algorithm/flow according to exemplary embodiments hereof;

FIG. 4 depicts a prototype system according to exemplary embodiments hereof; and

FIG. 5 depicts aspects of computing according to exemplary embodiments hereof.

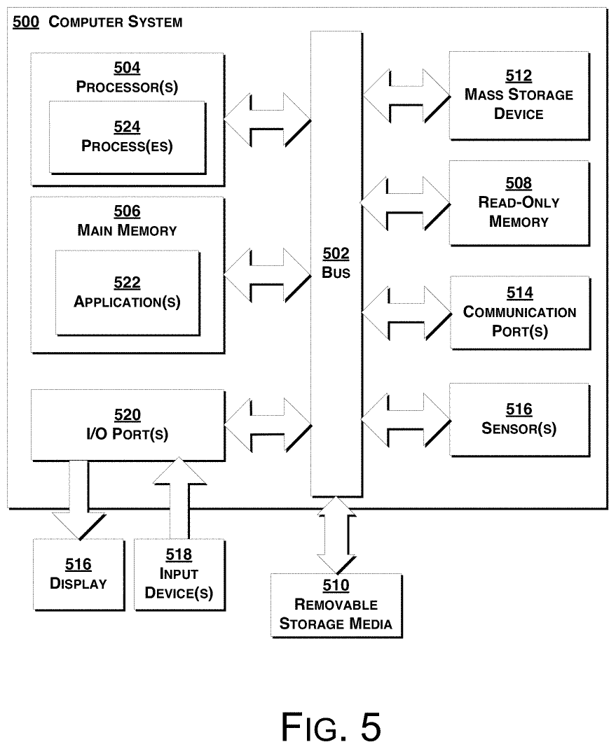

### DETAILED DESCRIPTION OF PRESENTLY PREFERRED EXEMPLARY EMBODIMENTS

### Glossary and Abbreviations

As used herein, unless used otherwise, the following terms or abbreviations have the following meanings:

API means Application Program(ing) Interface;

DNS means Domain Name System;

GTIN means Global Trade Item Number;

NFC means near field communication;

PoS means point of sale;

“QR code” means Quick Response Code (“QR code” is a trademark for a type of matrix barcode or two-dimensional barcode);

RFID means radio frequency identification;

URI means Uniform Resource Identifier;

URL means Uniform Resource Locator;

1D (or 1-D) means 1-dimensional;

2D (or 2-D) means 2-dimensional.

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### Overview and Background

As will be described, aspects hereof add product authenticity capabilities to existing barcodes such as 1D and 2D codes and does not require dedicated physical markings beyond standard barcodes. Instead, it adds layers of data on top of physical objects to improve the probability of confirming product are authentic, and conversely, to improve the probability of detecting counterfeit products. This approach is referred to herein as data driven product authenticity.

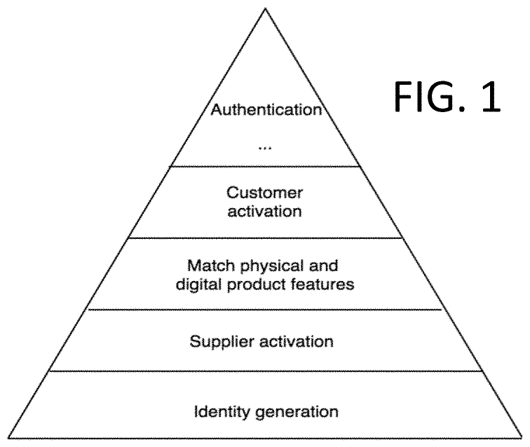

Product authentication may be considered a multi-layered process. With reference to an exemplary product authentication pyramid FIG. 1, each level of authentication reduces the possibility that a product is counterfeit.

The first layer (identity generation), may give an initial indication that a product is genuine. For example, a product may include a unique identifier, e.g., in a URI or the like printed on the product and/or on labeling or packaging associated with the product. If the identity of the product can be confirmed using the unique identifier, then the product may be genuine.

The next layer (supplier activation) may be used to determine/verify whether or not a product was activated by the supplier. Information that a product that was shipped by the supplier or manufacturer, which may provide a further indication of the product's genuineness. A non-activated product that ends up being sold could be a back-door or otherwise unauthorized sale. Item identity verification may rely on a single business rule or a trained model to better handle cases of suppliers that ship products but neglect scanning each product.

The next layer (matching product) may be used to determine whether an actual product physically matches the expected product. This layer may user imaging and/or other physical determinations to check the product. For example, a customer may capture an image of the product, to compare the product with expected characteristics (e.g., color, patterns, etc.) extracted from a product profile (e.g., as determined using the product identity).

The first three layers (described above) may be sufficient for data-driven product authenticity determination. However, additional layers of verification may be added. For example, embodiments hereof may also consider where similar products are being checked for authenticity. Products are often shipped in batches to a given geographic region, and so we may expect similar products to be scanned relatively close to each other. A product that is being scanned in a different geographic region may indicate a gray market or counterfeit market product.

As should be appreciated, each level provides additional authenticity checks and therefore additional confidence that a given product is genuine.

### DESCRIPTION

Authenticity of a product may be assessed by considering one or more aspects of the product, e.g., who made it, who ordered, is it tagged correctly, did it arrive at the expected destination, who bought it and where were similar products bought, etc.

A product's authenticity may thus be based on a combination of features that may be individually and/or collectively validated to provide an overall probabilistic assessment of the authenticity of the product.

Primary components that may be used to determine authenticity are the product itself and a product tag associated with the product. A tag may be embedded in the product and/or attached thereto. A tag preferably contains and/or encodes information about the product (e.g., size, content, etc.) as well as a unique identifier for the product. The information in/on a tag may be encoded in a machine-readable way, such as in a barcode (e.g., a 1D barcode or a QR code or like) or RFID tag (e.g., UHF EPC Gent, NFC, or the like). Each unique identifier links the associated physical product to a corresponding digital profile for that product. A digital profile may contain a product type description (preferably in human readable form) as well as a digital product fingerprint that may be used to authenticate the physical product.

A product's profile may also include a digital fingerprint of the tag that may be used, e.g., to make counterfeiting tags more difficult. A product's profile may contain a digital record of the product's lifecycle and/or history, such as when the tag was attached to the product, when the product left a factory, when a product is scanned by a customer, etc.

Various degrees of product authenticity may be acceptable, but in preferred cases, a product is only considered to be authentic when the product and its tag are both considered genuine. As used here, the term “genuine” means that the manufacturing, distribution and sale of the product abided by terms agreed upon by all parties. This means that products that were manufactured by licensed suppliers but sold out the back door are considered counterfeits, even though physically these products would be indistinguishable from a genuine product. Those of ordinary skill in the art will realize and appreciate, upon reading this description, that, by including digital as well as physical information about a product it be fully authenticated.

The following table provides example scenarios of tag and product evaluations. As used in the table, the term “stolen” includes spontaneous theft, for example employees stealing goods at the factory, as well institutionalized theft, sanctioned by management (e.g., backdoor channel sales or distribution). The term “counterfeit” means a product and/or tag are imitations.

| | | tag | |
|---|---|---|---|
| | | and | |
| | | Product | Description of |
| Tag | Product | match | possible scenario |
| stolen | stolen | yes | A genuine tag placed on a genuine |
| | | | product. Either a new tag was placed on |
| | | | the product by an unauthorized third |
| | | | party. In this case the product has not |
| | | | been activated, or the product was |
| | | | activated correctly but was never |
| | | | scannedby an authorized PoS (Point |
| | | | of Sale) or activation scanner. |
| | | | The tag product profileand product |
| | | | profile match however. |
| stolen | stolen | no | Same as above, but the actual |
| | | | product type does not match the |
| | | | expected product type. |
| stolen | counterfeit | yes | A genuine tag placed on a counterfeit |
| | | | product. The tag product type matches |
| | | | that of the product. The product's |
| | | | history contains irregularities (see |
| | | | above), and the product's visible |
| | | | characteristics exhibit discrepancies |
| stolen | counterfeit | no | Same as above, but the tag was placed |
| | | | on a product of the wrong product type |
| counterfeit | stolen | yes | A copied tag placed on a genuine |
| | | | product. The product's visual |
| | | | characteristics differ from that |
| | | | of a genuine product. Furthermore, |
| | | | the product's history shows |
| | | | irregular patterns. |
| counterfeit | stolen | no | Same as above, but product type |
| | | | does not match. |
| counterfeit | counterfeit | yes | A counterfeit tag (containing a correct |
| | | | URI) on a counterfeit product. Product |
| | | | type matches, otherwise all above |
| | | | mentioned discrepancies apply. |
| counterfeit | counterfeit | no | Same as above, but product type |
| | | | does not match. |

The table above provides a non-limiting set of example cases, and those of ordinary skill in the art will realize and appreciate, upon reading this description, that different and/or other example cases may be covered and are contemplated herein.

### Architecture

Embodiments hereof work with any product with which a tag (such as a barcode, QR code, NFC or UHF RFID tag, or the like) may be associated. Additional physical markers (e.g. watermarks and the like) or manufacturing processes to help authentication are not required (though they may be present and may also be used if present).

As should be appreciated, the exemplary architecture does not require a proprietary client-side application, although one may be used.

In preferred implementations a physical product may be associated with a (digital) item identity through a URI (uniform resource locator). The URI may be encoded in a machine-readable way, a QR code being a presently preferred choice. This approach allows for the use of at least two factors to authenticate a product, namely digital product data and the product's physical attributes.

The digital authentication of a product may apply or consider rules (e.g., business rules or the like, such as, e.g. a product can only be bought once), and may be based on well-known patterns that may be inferred over time. The rules may be set up, e.g., by domain experts and/or by the product manufacturer and/or distributor.

Physical authentication of a product may, e.g., be image based (e.g., using a user-provided picture of the product).

In preferred scenarios, a product may be considered authentic when both digital authentication and physical authentication are positive. Conversely, a product may be considered counterfeit (or not authentic) when either digital authentication or physical authentication is negative.

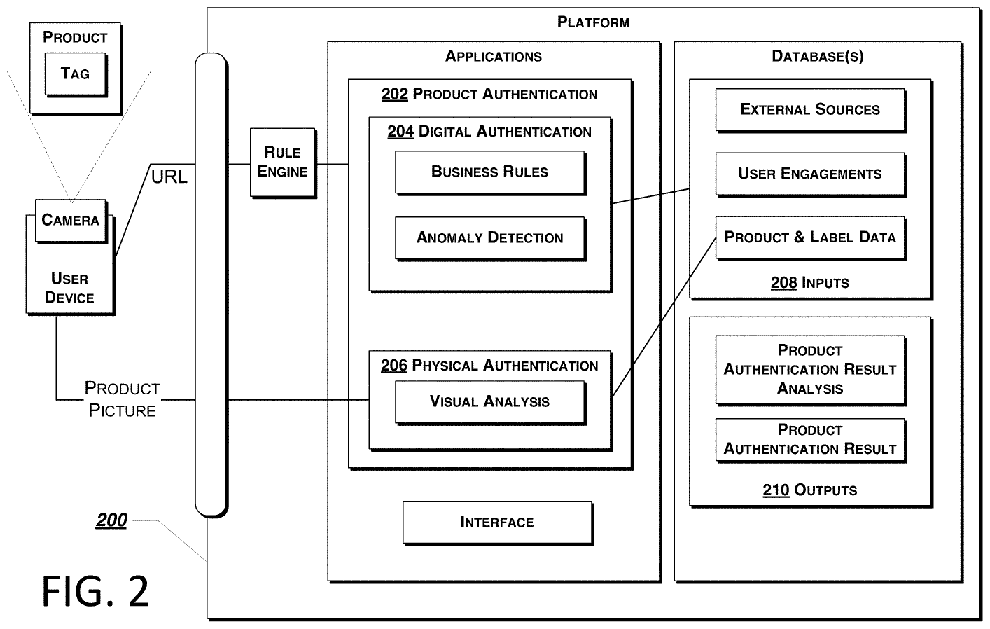

FIG. 2 shows an exemplary architecture according to embodiments hereof, in which a system 200 may include a product authentication module (or mechanism(s)) 202.

Aspects of the system 200 may be carried out on and/or implemented by one or more computers or computer systems. An exemplary computer system is described in detail below.

### Product Authentication Module (Mechanism(s)) 202

The product authentication module 202 may include component mechanisms to authenticate a product through its digital and physical attributes, namely digital authentication mechanism(s) 204 and physical authentication mechanism(s) 206.

A component mechanism (e.g., authentication mechanism(s) 204 and physical authentication mechanism(s) 206) takes an input, for example the state of a product record, and returns a value (e.g., between 0 and 1) to indicate the probability that a product is authentic. The product authentication module may execute all necessary and sufficient authentication components and combine all authentication values (for example by taking their average) to determine an overall authentication score. This information may be stored in the output module and used for further analysis.

An entry point to the data-driven product authenticity system is a tag (e.g., a 2D barcode) associated with a product and which contains or encodes a URI. This URI is the digital address of a resource that represents the physical product in the Web. Product authentication is only accessed if the product that is being scanned has not yet been authenticated. The routing may be decided by a context-aware rule-engine. Context, in this case, being the state of the resource that represents the scanned product, and information that the user submitted as part of the browser information and location. This entry point may, at the same time, be activating the digital authentication component whereas the physical authentication is activated when the user submits a picture of the product.

### Digital Authentication 204

The digital authentication component (mechanism(s)) 204 contains one or more models designed for specific use cases. They obtain data from the input module, such as the current or past state(s) of products, catalog metadata or external sources, etc.

Models may be symbolic or non-symbolic. Symbolic rules may be written in a formal (though preferably human-readable) representation of business logic. For example, a rule could define:
if (item.leftFactory==True) then return 1 else return 0

Non-symbolic models are rules that are based on machine learning. Machine learned rules may be automatically distilled from training data. For example, anomaly detection may be used to discover unusual product scan behaviors by customers (which may be an indication, e.g., of parallel imports).

### Physical Authentication 206

The system 200 allows users to determine a visual fingerprint of the physical product using, e.g., a picture of the product (taken, e.g., with the user's mobile phone). The visual fingerprint may then be compared to a stored or otherwise known fingerprint of the product. As should be appreciated, physical authentication is about matching the physical product to a known product fingerprint of that product type. Determining a product's type is possible, among other reasons, because the system knows the label of each product that is being sold.

Preferably the system has a model that has been trained using one or more known product images. This training may be done by the product manufacturer/provider, or crowd-sourced, and the model may be provided to the system. This model may then be applied to a user-submitted picture to determine a probability distribution over all products known for the model. A value for the product type the picture contained may be returned. If the user sent a picture of the correct product, it will increase the overall authenticity score, otherwise it may lower it, possibly drastically.

### Inputs 208

Inputs 208 consists of product resource and product type resource profiles and events and actions representing interactions of resources with their environment. Actions may include, for example, scans by users. Events may, for example, be triggered when a product is shipped, which changes the intrinsic state of a product. Additionally, inputs may include user profiles. These user profiles help to determine if a product has been authenticated or not or if a new user is using an already authenticated product. These user profiles do not have to identify users precisely, since the workflow does not require any type of explicit user authentication. External data sources may represent, for example, weather reports, which could be used to identify seasonal trends.

### Outputs 210

Output data 210 includes the result of product authentication activities. Each part of the product authentication workflow results in an action. These may be further aggregated, which again create actions. Furthermore, actions may trigger rules, either for data analysis or to trigger logic. For example, a rule could warn of increasing counterfeit activities in a certain region.

### Algorithm

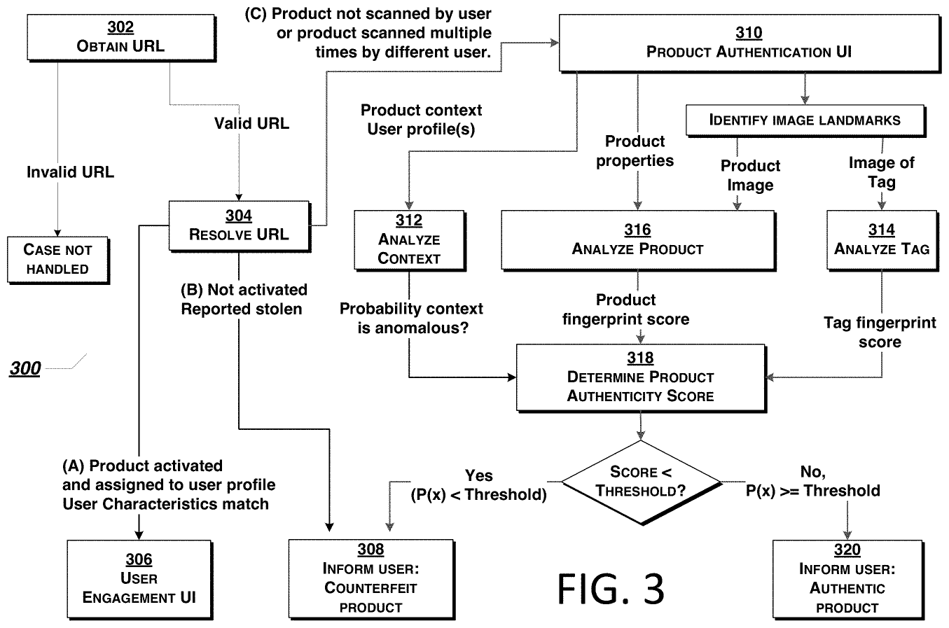

FIG. 3 shows an example flowchart for an algorithm 300 according to exemplary embodiments hereof. The algorithm may be carried out using, e.g., the architecture shown in FIG. 2.

Scan Tag and Obtain URI/URL

First, a user (consumer, brand employee, retailers or the like) scans the product tag to obtain/determine the product identifier. The user may use a generic application on their mobile phone or the like. For the sake of this description, the tag may contain a 2D barcode (e.g., a QR code) encoding or containing a URI or some link containing the product identifier. In some embodiments a generic native QR code reader application (such as a camera application on the user's device) may be used. An advantage of using a generic, pre-installed QR code reader application is ease of use, as a user does not have to install an additional application or manually type a URI to access a Web application. A downside of using a generic application is that counterfeit tags that do not contain a valid identity cannot be detected through this approach. As should be understood, a tag may be the “man in the middle” for an attack on the system. Thus, if a counterfeiter not only copies products but also the tags and the digital experience, a customer may be misled into believing the product is genuine.

Resolve URL

If the URI obtained from the tag (at 302) is a valid URL (with respect to form), then the URL is resolved (at 304) (e.g., using a DNS server).

If the URI is genuine (i.e., a valid URI), then resolution (at 304) may result in one of three paths:
(A) The item has already been activated by the same user/customer, in which case the user is redirected (at 306) to a page other than the product authentication UI.
(B) The item has not yet been activated, which means it should not be on the market, or the item is reported as stolen. In these cases, the user will be informed (at 308) that the item is not genuine.
(C) This item may legitimately be acquired, and the user is redirected (at 310) to product authentication Web-based application.

Product Authentication UI 310

Product Authentication (at 310) aims to verify the authenticity of a product.

In preferred embodiments, the product authentication mechanism 202 produces a product authenticity score (preferably as a probability or value in the range 0 to 1) indicative of the genuineness of the product.

Physical aspects of a product may be obtained by analyzing a picture of the product (e.g., taken by the user) and determining a digital fingerprint from the image of the physical product. Each product belongs to a product type and each product type is associated with a digital product fingerprint, to which the determined product fingerprint is compared. Fingerprints for product types may be obtained, e.g., by training a deep neural network with quality product images.

A product's context may also be analyzed (at 312) to determine whether or not the product is authentic. This may include analyzing supply chain data, such as the supplier, the store or region for which a product was created, user reviews, etc. This information may be used to extract patterns for forecasting, anomaly detection, etc.

A product's context may use any (or all) traceability data from and about the product, stored in the database and/or derived from stored data. A product's context may include, e.g., whether the product was activated at manufacturing time, information related to transportation of the product, etc. Missing and/or contradictory traces may provide an indication of an inauthentic or unauthorized product.

Physical Authenticity

The user may be asked to take or retake a picture of the product since scanning a QR code or the like with a generic QR reader does not automatically send an image to the API.

The system compares the content of the image against expected properties, which comprise a product fingerprint:
Analyze tag 314: The visual properties of its tag (e.g., image entropy, structural elements, font types, branding (e.g. made in Italy)).
Analyze product 316: The visual properties of the product, such as type (if the full item is visible, color, image entropy, etc.)

The tag analysis (at 314) may produce a tag fingerprint score (preferably as a probability or value in the range 0 to 1, with a higher value indicative of greater likelihood of genuineness). The product analysis (at 316) may produce a product fingerprint score (also preferably as a probability or value in the range 0 to 1, with a higher value indicative of greater likelihood of genuineness).

Analyze Product Context 312

The system may leverage explicit and implicit information collected about individual products to create a holistic picture of a product's lifecycle. The may be done to identify out of the ordinary events that could indicate counterfeit market activity. Such use cases, may, e.g., consider the following dimensions:
Customer satisfaction: How satisfied were customers who bought a similar product? A customer who unknowingly bought a low-quality counterfeit will more likely leave a negative review be less likely to leave a negative review.
Customer scans: Where customers scan their products. The aim is to detect outliers. A product scanned in an unexpected region could indicate a possible counterfeit (or parallel import).
Manufacturing or supply chain scans: scans that happened at manufacturing time or in the supply chain may also be considered. A product that was not scanned at the manufacturing facility or at a particular step in the supply chain could potentially identify a gray market or backdoor goods item.

The context analysis (at 312) may produce a context score (also preferably as a probability or value in the range 0 to 1), indicative of whether the context is considered anomalous (a lower score) or normal (a higher score).

Determine Product Authenticity 318

A product authenticity score may then be determined (at 318) using one or more of the scores determined by the context analysis (at 312), and/or the tag analysis (at 314) and/or the product analysis (at 316). As should be appreciated, each of the analysis (at 312, 314, 316) produces a corresponding score (tag fingerprint score, product fingerprint score, and context score), and the product authenticity score may be a weighted sum of each of these scores.

product authenticity score=(W1*tag fingerprint score+W2*product fingerprint score+W3*context score)/N

Where W1, W2, and W3 are weights (e.g., integer values) applied to the various scores and N is adjusted to maintain the final product authenticity score in the range 0 to 1. For example, if W1, W2, and W3 are integers, then N=W1+W2+W3. The weights may be used to give more value or credence to one or more of the three scores.

In one case, the product authenticity score is a simple average of the three scores (i.e., with the weights all equal to 1), as shown here:

product authenticity score=(tag fingerprint score+product fingerprint score+context score)/3

Although an example function is shown to determine the product authenticity score, Those of ordinary skill in the art will realize and appreciate, upon reading this description, that different and/or other functions and/or techniques may be used.

Having determined the product authenticity score, if the product authenticity score is above a certain threshold, then the item may be considered to be genuine (at 320), otherwise it is deemed to be a counterfeit (at 308), with the user appropriately informed.

Variation

Variations of the workflow described here are contemplated. For example, the workflow may be changed to work with a dedicated application or scanner. This may remove the man-in-the-middle attack described above, in that a URI with an invalid item identity would be recognized, thus removing the risk of counterfeiters using their own product identities.

Real Time

As should be appreciated, the system described herein preferably operates in real time.

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time computation may refer to an online computation, i.e., a computation that produces its answer(s) as data arrive, and generally keeps up with continuously arriving data. The term “online” computation is compared to an “offline” or “batch” computation.

### Prototype Implementation

A fully functioning exemplary prototype was developed to validate the system.

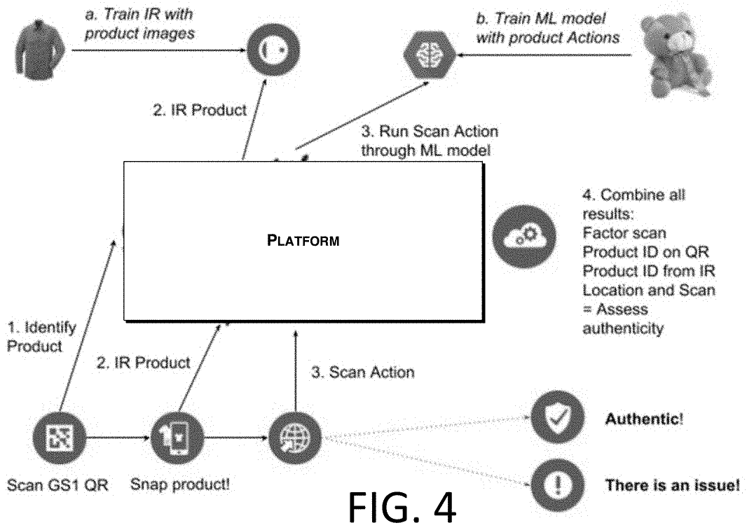

With reference to FIG. 4, the prototype implements use cases where a user scans a QR code using a generic QR reader (at 1), such as the default camera application on iOS, to access the URL of the data-driven product authentication workflow. The URL comprises a valid GS1 Digital Link, which contains the product type number (GTIN) and the item serial number.

The prototype used garments, particularly shirts, as the products.

A first dialog provides the user with some basic product information and a button to continue the authentication workflow by scanning the product (at 2). In the background (at 3), the accessing the URL created a “scan action”. Scan actions are created when user scans (for the first time) a product (a shirt) the user bought, most likely with the intention of performing an authentication. Products of a certain type are likely sold and scanned in the same market(s). Which means if a shirt is being scanned in an unusual space, this could be an indication for grey market activity. Therefore, the location of a scan provides one factor in the multi-factor authentication score. A random forest model was trained on a large set of existing scan actions to automatically classify actions. Those data were then used as training data to train a simple fully connected neural network to learn whether or not a user scan location is anomalous. When deployed, the model performs a binary classification returning a value between 0 and 1. The closer the 1, the less likely the user scan is an anomaly. This model runs on a Cloud Machine Learning Engine (step 2a).

To authenticate the physical product, the user selects “Scan to Authenticate”. The next dialog asks the user to take a picture of the product itself and sends it to the system (step 3). Next, a visual product search is performed (using a pre-trained and crowd source trained image recognition engine) with the picture submitted by the user. If the product type identified in the image matches the product type that the user bought, the match probability is return, otherwise 0 is returned (step 3b). When both the user scan classification and the product identification are complete, the average of the aforementioned authentication values and the binary property supplier scan (whether or not this product officially left the factory or was stolen) gives the final authentication score of a product. Each product type defines an authenticity threshold. Only if the final authentication score exceeds that threshold, the product is considered to be authentic (step 4).

### DISCUSSION

Approaches to product authentication are this provided.

These approaches have various advantages, including:
It does not require changes to the manufacturing process
Product authentication improves over time as more data is collected and models are improved
It works for back door sales, and gray market imports where products are technically authentic but sold illegally.

Thus is provided a multi-factor product authentication system that utilizes both digital and physical characteristics as well as machine learning determine the authenticity of a product.

Implementations may include one or more of the following:
The system may be accessed by end-users who have access to a smartphone.
A URI of a product may be encoded in a QR code (or any barcode with enough capacity to hold a resource location) and may be attached to a product. As should be appreciated, this labels a physical product with its digital representation that may be read with any smartphone that has QR reading capabilities.
The digital representation of the product may contain intrinsic and/or extrinsic properties of a product. The digital representation of the product may also be assigned to a product type resource which may describe a set of products with common features.
In addition to products and product types, groups of products as well as external information may be used to inform authentication scores.
Scanning a QR code using a generic QR code reader may lead a user to a Web app to authenticate the product.
A native app may be used, which would allow for (client-side) verification and validation of the URI.
Upon scanning the QR code, a series of formal models may be executed to validate different features of the product. These models may be rule-based models or machine learning models. Each model, when applied to either the physical or digital representation of the product may return a value (a probability) that the product, which the user wants to authenticate, is authentic. These probabilities may be combined to an overall authentication score, between 0 and 1. An authentication threshold may be defined per product (or for a set of products), which may define a minimum overall authentication score for a product to be considered authentic.
Rule-based models may represent business logic in an executable way. Rules may be declared to be triggered based on intrinsic or extrinsic characteristics of a single product.
Machine learning models may learn patterns from a set of related products, with the aim of providing an authentication score of a single product. In addition to product information, external sources may also be used during training and execution time.
A system may also be able to authenticate a physical object and compare the physical object to the digital representation of that object.
A visual fingerprint of the product may be used to perform the physical authentication. This may be done by a consumer taking and submitting a picture of product, e.g., using the smartphone camera.
The system may use computer vision to lookup the product in the picture and compare the product it found with the product in the tag. If it is a match, the product fingerprint may be returned, a value between 0 and 1 representing how confident the model is about the match. If the product identified in the picture does not match the digital product, the score may be 0.
In addition to matching a product and label, the previous approach may also inform the identification of counterfeit products of a product that has a digital resource. This may be done in isolation, by taking the authentication confidence as an indicator, or by analyzing a set of similar fingerprinting authentication scores and detecting outliers.
Optionally, a label containing the QR code may also be photographed and submitted for fingerprinting as described for the physical product.
The different authentication systems may be sent as inputs to a machine learning algorithm that may provide an authenticity score based on the different authentication factors.
This authenticity score may then be returned to the consumer or used internally to generate alerts.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that may implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 4 is a schematic diagram of a computer system 500 upon which embodiments of the present disclosure may be implemented and carried out.

According to the present example, the computer system 500 includes a bus 502 (i.e., interconnect), one or more processors 504, a main memory 506, read-only memory 508, removable storage media 510, mass storage 512, and one or more communications ports 514. Communication port(s) 514 may be connected to one or more networks (not shown) by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process may include, e.g., a processor and those devices such as input devices and output devices that are appropriate to perform the process.

Processor(s) 504 may be any known processor, such as, but not limited to, an Intel® Itanium® or Itanium 2® processor(s), AMD® Opteron® or Athlon MP® processor(s), or Motorola® lines of processors, and the like. In the context of deep learning, the processors are preferably GPUs (Graphics processing units) and TPUs (Tensor Processing Units). Communications port(s) 514 may be any of an Ethernet port, a Gigabit port using copper or fiber, or a USB port, and the like. Communications port(s) 514 may be chosen depending on a network such as a Local Area Network (LAN), a Wide Area Network (WAN), or any network to which the computer system 500 connects. The computer system 500 may be in communication with peripheral devices (e.g., display screen 516, input device(s) 518) via Input/Output (I/O) port 520.

Main memory 506 may be Random Access Memory (RAM), or any other dynamic storage device(s) commonly known in the art. Read-only memory (ROM) 508 may be any static storage device(s) such as Programmable Read-Only Memory (PROM) chips for storing static information such as instructions for processor(s) 504. Mass storage 512 may be used to store information and instructions. For example, hard disk drives, an optical disc, an array of disks such as Redundant Array of Independent Disks (RAID), or any other mass storage devices may be used.

Bus 502 communicatively couples processor(s) 504 with the other memory, storage and communications blocks. Bus 502 may be a PCI/PCI-X, SCSI, a Universal Serial Bus (USB) based system bus (or other) depending on the storage devices used, and the like. Removable storage media 510 may be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium may store (in any appropriate format) those program elements which are appropriate to perform the methods.

As shown, main memory 506 is encoded with application(s) 522 that support(s) the functionality as discussed herein (the application(s) 522 may be an application(s) that provides some or all of the functionality of the services/mechanisms described herein, e.g., VR sharing application 230, FIG. 2). Application(s) 522 (and/or other resources as described herein) may be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret or otherwise perform the logic instructions of the application(s) 522. Execution of application(s) 522 produces processing functionality of the service related to the application(s). In other words, the process(es) 524 represent one or more portions of the application(s) 522 performing within or upon the processor(s) 504 in the computer system 500.

For example, process(es) 524 may include an AR application process corresponding to VR sharing application 230.

It should be noted that, in addition to the process(es) 524 that carries(carry) out operations as discussed herein, other embodiments herein include the application(s) 522 itself (i.e., the un-executed or non-performing logic instructions and/or data). The application(s) 522 may be stored on a computer readable medium (e.g., a repository) such as a disk or in an optical medium. According to other embodiments, the application(s) 522 may also be stored in a memory type system such as in firmware, read only memory (ROM), or, as in this example, as executable code within the main memory 506 (e.g., within Random Access Memory or RAM). For example, application(s) 522 may also be stored in removable storage media 510, read-only memory 508, and/or mass storage device 512.

Those skilled in the art will understand that the computer system 500 may include other processes and/or software and hardware components, such as an operating system that controls allocation and use of hardware resources. As shown in FIG. 2, the device 200 (a computer system) may include one or more sensors 216, and in the examples in FIGS. 1A-1B, the VR sharing system 122 may include one or more sensors 132.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which may include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, may cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that may capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs”, and includes the case of only one ABC.

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

As used herein, a range specified as “X to Y” shall include X and Y unless otherwise stated.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification may be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

Thus, is provided an augmented reality system that combines a live view of a real-world, physical environment with imagery based on live images from one or more other devices.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A method of determining authenticity of a physical product, the method comprising:
determining an identifier for the product, said identifier being encoded in indicia associated with the product;
using said identifier to access a product authentication system;
said product authentication system:
determining a first score based on an analysis of the product;
determining a second score based on an analysis of at least one tag associated with the product; and
determining a product authenticity score as a function of the first score and the second score; and then
based on said product authenticity score, providing an indication of authenticity of the product.

2. The method of claim 1, wherein said indicia are encoded, at least in part, in and/or on the product.

3. The method of claim 1, wherein said indicia are encoded, at least in part, in and/or on the at least one tag associated with the product.

4. The method of claim 1, wherein said indicia are encoded, at least in part, in a barcode.

5. The method of claim 4, wherein the barcode comprises a two-dimensional barcode.

6. The method of claim 1, wherein said indicia are encoded, at least in part, on a radio frequency identification (RFID) tag and/or an near field communication (NFC) tag.

7. The method of claim 1, wherein the indicia comprise a uniform resource locator (URL).

8. The method of claim 1, wherein the first score is determined based on an analysis of one or more images of the product.

9. The method of claim 8, wherein the one or more images of the product are obtained from a user's device.

10. The method of claim 1, wherein the second score is determined based on an analysis of at least one tag associated with the product.

11. The method of claim 1 wherein the analysis of the at least one tag is based on an analysis of one or more images of the at least one tag.

12. The method of claim 11, wherein the one or more images of the at least one tag are obtained from a user's device.

13. The method of claim 11, wherein the one or more images of the at least one tag are obtained from a dedicated and/or automated scanner.

14. The method of claim 13, wherein the dedicated and/or automated scanner comprises a handheld barcode scanner or an RFID gate.

15. The method of claim 1, wherein the first score is a value in the range 0 to 1 indicative of a first probability that the product is authentic.

16. The method of claim 1, wherein the second score is a value in the range 0 to 1 indicative of a second probability that the at least one tag is authentic.

17. The method of claim 1, wherein the product authenticity score is determined as an average of a weighted sum of at least the first score and the second score.

18. The method of claim 1, further comprising: said product authentication system
determining a third score based on an analysis of a context of the product, and wherein said product authenticity score is a function of the first score and the second score and the third score.

19. The method of claim 18, wherein the context of the product is based on one or more of: (i) whether the product was activated at manufacturing time, (ii) information related to transportation of the product; and (iii) missing and/or contradictory information about the product.

20. The method of claim 18, wherein the third score is a value in the range 0 to 1 indicative of a third probability that the context is anomalous.

21. The method of claim 20, wherein the product authenticity score is determined as an average of a weighted sum of at least the first score and the second score and the third score.

22. The method of claim 1, wherein the product authenticity score is determined in response to a request from a user.

23. The method of claim 22, wherein the request was initiated based on a scan of indicia associated with the product.

24. The method of claim 1, wherein the indication of authenticity of the product is determined based on the product authenticity score relative to a threshold value.

25. The method of claim 1, wherein the analysis of the product uses a digital representation of the product.

26. The method of claim 1, wherein the product authentication system is accessible as a web-based application.

27. The method of claim 1, wherein using said identifier in (B) comprises resolving a URL (Uniform Resource Locator) associated with the product.

28. The method of claim 27, wherein the URL is encoded in the indicia associated with the product.

29. The method of claim 28, wherein accessing the product authentication system is performed in response to scanning the indicia associated with the product.

30. The method of claim 1, wherein at least one of the first score and/or the second score is determined using external information.

31. The method of claim 18, wherein at least one of the first score and/or the second score and/or the third score is determined using external information.

32. The method of claim 1, wherein at least one of the first score and/or the second score is determined using one or more formal models.

33. The method of claim 18, wherein at least one of the first score and/or the second score and/or the third score is determined using one or more formal models.

34. The method of claim 1, wherein at least one of the first score and/or the second score is determined using at least one machine-learning model.

35. The method of claim 34, wherein the at least one machine-learning model was trained using a set of related products.

36. The method of claim 18, wherein at least one of the first score and/or the second score and/or the third score is determined using at least one machine-learning model.

37. The method of claim 36, wherein the at least one machine-learning model was trained using a set of related products.

38. A system comprising:
(a) hardware including memory and at least one processor, and
(b) a service running on said hardware, wherein said service is configured to:
perform the method of claim 1.

39. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 1.
